(19) United States
(12) Patent Application Publication
(10) Pub. No.: US 2025/0171303 A1
(43) Pub. Date: May 29, 2025

(54) NITRIC ACID PLANT FOR PRODUCING NITRIC ACID

(71) Applicants: thyssenkrupp Uhde GmbH, Dortmund (DE); thyssenkrupp AG, Essen (DE)

(72) Inventors: Dirk RITTER, Essen (DE); Daniel BIRKE, Melle (DE)

(73) Assignees: thyssenkrupp Uhde GmbH, Dortmund (DE); thyssenkrupp AG, Essen (DE)

(21) Appl. No.: 18/837,297

(22) PCT Filed: Feb. 10, 2023
(86) PCT No.: PCT/EP2023/053307

§ 371 Date: Aug. 9, 2024

(30) Foreign Application Priority Data
Feb. 11, 2022 (BE) BE 2022/5094
Feb. 11, 2022 (DE) 10 2022 201 476.6

(51) Int. Cl. C01B 21/40

(52) U.S. Cl. CPC C01B 21/40

(57) ABSTRACT

A nitric acid plant for producing nitric acid comprises a machine train comprising a drive means, in particular a steam turbine or electric motor or as case may be a gas turbine, an air compressor, a nitrous gas compressor and a gas expander, wherein the machine train is a single shaft machine, wherein the air compressor is a compressor having an axial inlet or an axial outlet which is arranged at the end side of the machine train and/or the gas expander is configured with an axial inlet or an axial outlet and/or the nitrous gas compressor is configured with an axial inlet or an axial outlet.

The present invention relates to a nitric acid plant for producing nitric acid according to the preamble of claim 1.

Employed nitric acid plants include for example plants operating according to the single pressure process (also known as the mono pressure process) or the dual pressure process. Reference may be made to EP 0 945 400 B1 for further details. However, in both cases the nitric acid plant has a similar construction and comprises substantially a drive means, in particular a steam turbine (or electric motor or in some cases a gas turbine), an air compressor, a nitrous gas compressor and a gas expander. In the mono pressure processes the nitrous gas compressor is omitted.

The aforementioned components are coupled to one another using a rotation transmission means. It is provided that the steam turbine drives the machine train with the waste process heat generated. The air compressor compresses the required air while the nitrous gas compressor assumes the function of compressing the NOx gas. The gas expander at the other end of the machine train utilizes the tail gases and preferably also provides the necessary drive. The contexts, in particular the chemical and process engineering processes for producing nitric acid, are well known to those skilled in the art. In this regard reference may also be made to EP 0 945 400 B1.

According to the current state of the art the sequence of the individual machines in a single shaft turbomachine in a nitric acid plant, also known as an in-line machine, for nitric acid dual-pressure plants is fixed on account of the different speeds of rotation. It has been necessary to adhere for example to the following sequence: steam turbine, nitrous gas compressor, air compressor, gas expander. WO 03/070634 A1 discloses a nitric acid plant for producing nitric acid according to the one pressure or the dual-pressure process in which an air precompression stage, a NOx precompression stage and two expansion stages, each comprising a radial inlet and a radial outlet, can be arranged in this sequence along a drive shaft and, as case may be, connected to one another with gearboxes. The invention now described here builds on the invention according to the utility model specification DE 20 2016 002 126 U1, since it is now possible to arrange the individual machines of the single shaft turbomachine in the nitric acid plant variably and to enhance the energy efficiency of a nitric acid dual-pressure plant on the basis of the present invention. A nitric acid plant for producing nitric acid is disclosed for example in DE 10 2016 003 950 A1. The essential aspect of the invention according to DE 10 2016 003 950 A1 is that the aforementioned components may be operated at a common speed of rotation and are thus coupled to one another to transmit a rotational motion without one or more transmission gearboxes. The advantage is especially the saving of an otherwise required transmission and the accompanying cost-saving and a reduction in maintenance requirements but also an enhancement of the efficiency of the machine train and thus the yield of nitric acid and the possibility of arranging the machines in any desired sequence within the machine train.

CN 203130565U has also disclosed a combined air and nitrous gas compressor for nitric acid production. This document describes inter alia that the impeller of the first stage of the air compressor unit, the impeller of the second stage of the air compressor unit, the impeller of the first stage of the nitric oxide unit and the impeller of the second stage of the nitric oxide unit are intended to be half-open impellers having a high efficiency and an axial air inlet. A radial compressor with axial suction is used here as the air compressor and the nitrous gas compressor. This is a so-called geared turbo, also referred to as a multi shaft machine, in contrast to the single shaft machines mentioned in the present patent. In a geared turbo, shafts of different machines are driven at different speeds rotation through a central gearbox for example.

Although the prior art already describes usable nitric acid plants for producing nitric acid by the dual-pressure process comprising a machine train there remains a need for improvement, in particular in terms of further enhancing efficiency.

This is addressed by the present invention which has for its object to provide an improved nitric acid plant, in particular an improved machine train configured as a single shaft machine in a nitric acid plant according to the dual-pressure process where advantages in terms of efficiency are achievable.

According to the invention this object is achieved by a nitric acid plant for producing nitric acid having the characterizing features of claim 1. Since the air compressor is a compressor for a nitric acid plant according to the dual-pressure process having an axial inlet which is arranged at the end side of the machine train it is possible to achieve a further enhancement in efficiency, in particular relative to an air compressor of a single shaft machine having a radial inlet. The end-side arrangement makes it possible to realize axial suction in the simplest possible way. Axial suction and the resulting reduction in flow (deflection) losses and optimization of the inflow profiles can increase the efficiency of the air compressor by 0.1% to 4% for example. This results in better energy efficiency of the entire nitric acid plant, thus making it more environmentally friendly and reducing operating costs.

Further advantageous refinements of the proposed invention can be found in particular in the features of the dependent claims. The subject matter and features of the different claims may in principle be combined with one another as desired.

In an advantageous embodiment of the invention, it may be provided that the gas expander is configured with an axial inlet or an axial outlet, wherein the gas expander is arranged at the end side of the machine train, in particular at the other end relative to the air compressor. This measure makes it possible to realize an axial inlet or outlet of the gas expander in a simple manner. This means in particular that the air compressor may be a compressor having an axial inlet. It is likewise possible for the air compressor instead to be a compressor having an axial outlet. As case may be, the air compressor may also be a compressor having an axial inlet and an axial outlet.

In a further advantageous embodiment of the invention it may be provided that the air compressor, the drive means, the nitrous gas compressor and the gas expander are arranged in the aforementioned sequence or that the air compressor, the nitrous gas compressor, the drive means and the gas expander are arranged in the aforementioned sequence. Such an arrangement of the aforementioned components makes it possible to achieve in advantageous fashion an axial inlet or outlet of the air compressor and/or the gas expander (as case may be, this may also include a combination of an axial inlet and an axial outlet).

In a further advantageous embodiment of the invention, it may be provided that the nitrous gas compressor is configured with an axial inlet or an axial outlet, wherein the nitrous gas compressor is arranged at the end side of the machine train. This measure makes it possible to realize an axial inlet or outlet of the nitrous gas compressor in simple fashion (as case may be, this may also include a combination of an axial inlet and an axial outlet).

In a further advantageous embodiment of the invention it may be provided that the drive means, the air compressor, the nitrous gas compressor and the gas expander have a common drive shaft (the drive shafts of the individual machines are preferably connected by clutches) and thus have a common speed of rotation. Such an arrangement in principle comprises no gearboxes and, for example, efficiency losses due to gearboxes can therefore be avoided. In the present case the machine train is made up of machines such as for example an air compressor, a steam turbine (or electric motor or gas turbine), a nitrous gas compressor and a gas expander which run at a common speed of rotation for example and are connected by clutches, also known to those skilled in the art as “single shaft machines” or else “inline machines”.

In a further advantageous embodiment of the invention it may be provided that the drive means, in particular the steam turbine or electric motor or as case may be gas turbine, the air compressor, the nitrous gas compressor and the gas expander are adapted to run at the same speed of rotation, wherein the speed of rotation value may be varied during operation.

In a further advantageous embodiment of the invention, it may be provided that the air compressor, in particular the inlet of the air compressor, has an air filter connected upstream of it. This advantageously makes it possible to avoid undesired suspended matter from being sucked into the air compressor.

In a further advantageous embodiment of the invention, it may be provided that the air filter is oriented, in particular elevatedly mounted, in alignment with the air compressor, in particular the inlet of the air compressor. This makes it possible to achieve a further improvement in efficiency, in particular since the air auction path is straightened and undesired deflections can be avoided.

In a further advantageous embodiment of the invention, it may be provided that a feed pipe is arranged between the air compressor and the air filter, in particular between the inlet of the air compressor and the air filter. The air flow can be influenced through configuration of a feed pipe.

Further features and advantages of the present invention will become apparent from the following description of preferred exemplary embodiments with reference to the accompanying drawings. In the figures

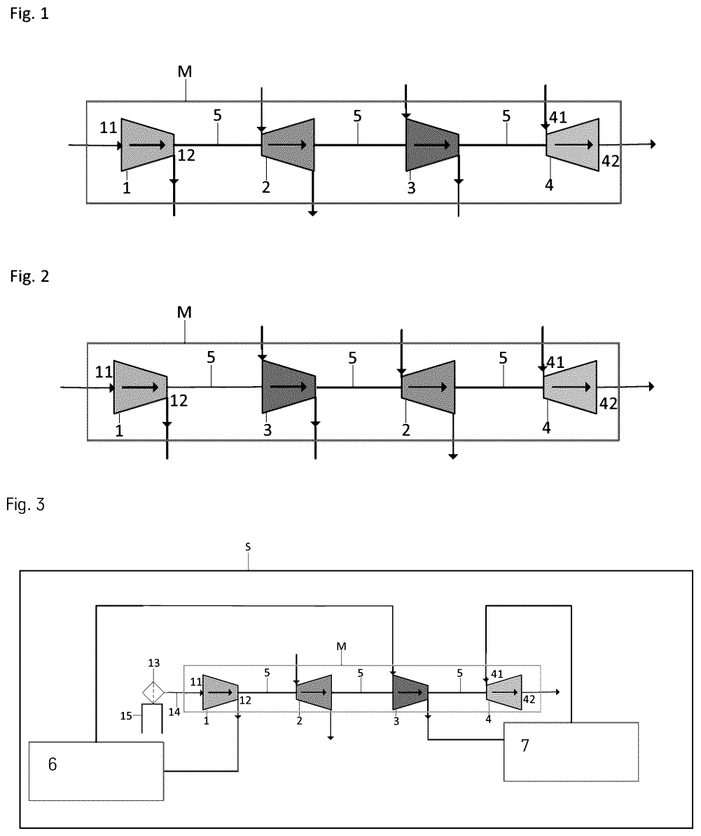

FIG. 1 shows a machine train of an inventive nitric acid plant for producing nitric acid in a schematic representation with the sequence air compressor, drive means, nitrous gas compressor, gas expander;

FIG. 2 shows a machine train of an inventive nitric acid plant for producing nitric acid in a schematic representation with the sequence air compressor, nitrous gas compressor, drive means, gas expander;

FIG. 3 shows a nitric acid plant according to the invention with a machine train in a schematic illustration.

The following reference signs are used in the figures:
M Machine train
S Nitric acid plant
1 Air compressor
2 Drive means, in particular steam turbine, or alternatively electric motor or gas turbine
3 Nitrous gas compressor
4 Gas expander
5 Drive shafts and output shafts with clutches
6 Apparatus for nitric acid process, in particular ammonia oxidation
7 Apparatus for nitric acid process, in particular absorption and residual gas cleaning
11 Inlet (suction port) of air compressor
12 Outlet of air compressor
13 Air filter
14 Feed pipe
15 Air filter pedestal
41 Inlet of the gas expander
42 Outlet of the gas expander

Of course, features and details described in the context of a process also apply in the context of the apparatus according to the invention and vice versa, such that reference is always or can always be made reciprocally with respect to the disclosure of the individual aspects of the invention. Moreover, any described process according to the invention can be carried out with the apparatus according to the invention. It is unimportant how the sequence (FIG. 1 to FIG. 3) of the inlets and outlets of the steam turbine and the nitrous gas compressor are arranged.

The terminology used herein serves only for the purpose of description of particular embodiments and is not intended to restrict the disclosure. As used herein, the singular forms “a/an” and “the” are also intended to include the plural forms unless the context clearly indicates otherwise. In addition, it will be clear that the terms “has” and/or “having”, when used in this description, specify the presence of the stated features, integers, steps, operations, elements and/or components, but do not rule out the presence or the addition of one or more other features, integers, steps, operations, elements, components and/or groups thereof. As used herein, the term “and/or” includes any desired element and all combinations of one or more of the associated, listed elements.

A nitric acid plant S comprises essentially one machine train M.

The following description relates essentially to the actual machine train M and the components essential to the understanding of the invention. A person skilled in the art is well aware of the other apparatuses of a nitric acid plant S, in particular their fluidic connections and further components. For further details reference may be made to EP 0 945 400 B1 for example.

Reference is first of all made to FIG. 1.

A machine train M of a nitric acid plant S for producing nitric acid essentially comprises a drive means 2, in particular a steam turbine (electric motor or gas turbine), an air compressor 1, a nitrous gas compressor 3 and a gas expander 4.

To transfer a rotational motion the aforementioned components are connected to one another using drive and output shafts 5 connected to one another via clutches. In the present patent the individual drive and output shafts of the individual machines are encompassed by the general term “drive shaft”. A common speed of rotation of the drive shafts 5 is preferably contemplated. Reference may be made for example to DE 10 2016 003 950 A1, in particular to the advantages resulting therefrom.

The drive and output shafts 5 connected via clutches preferably rotate at the same speed of rotation. The speed of rotation should essentially be variable. However, it may in principle also be provided that one or more gearboxes are interposed, in particular where a reduction in speeds of rotation is required.

The drive means 2, preferably configured as a steam turbine, accordingly drives the machine train M.

The air compressor 1 and/or the nitrous gas compressor 3 is preferably designed as a single- or multi-stage compressor. The air compressor 1 and/or the nitrous gas compressor 3 may also be referred to as an air compressor and/or nitrous gas compressor.

The gas expander 4 is essentially a turbine in which a pressurized gas expands to do work. The gas expander 4 can also drive the drive and output shaft 5 connected via clutches. The gas expander is preferably designed as a single- or multi-stage turbine.

As mentioned above the machine train M is part of a nitric acid plant S which comprises further components, for example condensers, reactors, pipe conduits etc. A person skilled in the art is aware of the connections and further components and these need not be more particularly elucidated. For further details reference may be made to EP 0 945 400 B1 for example.

According to the invention it is provided that the air compressor 1 is a compressor having an axial inlet 11 or an axial outlet 12 which is arranged on the end side of the machine train M, in particular that the air compressor 1 is arranged on the end side of the machine train M and the air compressor 1 is a compressor of a single shaft machine having an axial inlet 11 in a nitric acid plant S according to the dual-pressure process (this may as case may be also comprise a combination of an axial inlet and an axial outlet). A single- or multi-stage radial compressor having an axial inlet is also suitable. This measure allows the sucked-in air to enter the air compressor 1 with lower flow losses.

In a compressor of a single shaft machine with axial suction in a nitric acid plant S according to the dual-pressure process, also known as an axial turbo compressor, the gas to be compressed flows through the compressor in a substantially parallel direction, in particular parallel direction, to the drive shaft. The air compressor correspondingly has the aforementioned inlet 11 for air, which can also be referred to as the suction port, and an outlet 12 for the compressed air. The inlet 11 is correspondingly oriented axially while the outlet 12 may be aligned radially but also axially.

It may further preferably be provided that the gas expander 4 is a gas expander of a single shaft machine with axial suction in a nitric acid plant S according to the dual-pressure process. In a gas expander of a single shaft machine of a nitric acid plant according to the dual-pressure process the gas to be decompressed flows through the expander in a substantially parallel direction, in particular parallel direction, to the drive shaft. The gas expander has an inlet 41 and an outlet 42. The inlet or the outlet are preferably also oriented axially.

In this context it is further preferably provided that the gas expander 4 is provided at the other end of the machine train M, i.e. at the opposite side of the air compressor 1.

This results in the following preferred sequence of the components of the machine train in the axial direction, namely air compressor 1, drive means 2, nitrous gas compressor 3, gas expander 4. Such an arrangement is shown for example in FIG. 1. Also conceivable is a transposed arrangement of the nitrous gas compressor 3 and the drive means 2, i.e. air compressor 1, nitrous gas compressor 3, drive means 2, gas expander 4. Such an arrangement is shown in FIG. 2 for example.

Having regard to FIGS. 1 and 2 it may be noted that the machines, for example the steam turbine or NO compressor, may in principle be mirrored. That is to say the in- and outlets would be transposed. Numerous arrangement possibilities are conceivable in principle, such as especially that the gas expander 4 is configured with an axial inlet 41 or an axial outlet 42, wherein the gas expander 4 is arranged on the end side of the machine train M, in particular the other end relative to the air compressor 1, wherein especially the air compressor 1, the drive means 2, the nitrous gas compressor 3 and the gas expander 4 are arranged in the aforementioned sequence or the air compressor 1, the nitrous gas compressor 3, the drive means 2 and the gas expander 4 are arranged in the aforementioned sequence. It may likewise be provided for example that the nitrous gas compressor 3 is configured with an axial inlet or an axial outlet, wherein the nitrous gas compressor 3 is arranged at the end side of the machine train.

A nitric acid plant S having a machine train M is shown in FIG. 3.

It may preferably be provided that the air compressor 1, in particular the air inlet 11, has an air filter 13 connected upstream of it. It is preferable to provide a feed pipe 14 having a defined dimension between the air filter 13 and the air compressor 1, in particular the inlet 11 of the air compressor 1. The dimension of the feed pipe 14, in particular its length, can be used to affect the flow characteristics of the sucked-in air.

It is also preferable when the air filter 13 and the air compressor 1 and in particular the feed pipe 14 are arranged one behind the other in an axial direction and in particular horizontally to or in alignment with one another. To this end it may for example be provided that the air filter 13 is mounted on an appropriate pedestal 15 so that the air filter 13 and the air compressor 1, in particular the inlet 11 thereof, are in alignment with one another. It is especially intended to provide the straightest possible feed pipe 14 to minimize flow losses and enhance efficiency. The elevated mounting of the air filter 13 above floor-level also has the advantage in the case of dirt- and dust-affected floors that air is not sucked-in in proximity to the floor.

It is further preferably provided that the nitric acid plant S comprises an apparatus 6 for the nitric acid process, in particular ammonia oxidation, and an apparatus 7 for the nitric acid process, in particular absorption and tail gas cleaning.

1-9. (canceled)

10. A nitric acid plant for producing nitric acid by a dual-pressure process, comprising:
a machine train including:
a drive device,
an air compressor,
a nitrous gas compressor, and
a gas expander,
wherein the machine train is a single shaft machine,
wherein the air compressor is a compressor having an axial inlet or an axial outlet on a first end side of the machine train.

11. The nitric acid plant as claimed in claim 10, wherein the gas expander is configured with an axial inlet or an axial outlet, wherein the gas expander is arranged at a second end side of the machine train opposite to the first end side.

12. The nitric acid plant as claimed in claim 10, wherein the air compressor, the drive means, the nitrous gas compressor, and the gas expander are arranged in the aforementioned sequence or the air compressor, the nitrous gas compressor, the drive means and the gas expander are arranged in the aforementioned sequence.

13. The nitric acid plant as claimed in claim 10, wherein the nitrous gas compressor is configured with an axial inlet or an axial outlet, wherein the nitrous gas compressor is arranged at the first end side of the machine train.

14. The nitric acid plant as claimed in claim 10, wherein the drive means, the air compressor, the nitrous gas compressor and the gas expander are single shaft machines.

15. The nitric acid plant as claimed in claim 10, wherein the drive device, the air compressor, the nitrous gas compressor and the gas expander are adapted to run at the same speed of rotation, wherein the speed of rotation value may be varied during operation.

16. The nitric acid plant as claimed in claim 10, wherein the air compressor has an air filter connected upstream of it.

17. The nitric acid plant as claimed in claim 10, wherein the inlet of the air compressor has an air filter connected upstream of it.

18. The nitric acid plant as claimed in claim 10, wherein an air filter is oriented in alignment with the air compressor.

19. The nitric acid plant as claimed in claim 10, wherein an air filter is oriented and elevatedly mounted in alignment with the inlet of the air compressor.

20. The nitric acid plant as claimed in claim 16, wherein a feed pipe is arranged between the air compressor and the air filter.

21. The nitric acid plant as claimed in claim 16, wherein a feed pipe is arranged between the air filter and the inlet of the air compressor.

22. The nitric acid plant as claimed in claim 10, wherein the drive device is a steam turbine, electric motor, or gas turbine.
